(19) United States
(12) Patent Application Publication
(10) Pub. No.: US 2010/0192191 A1
(43) Pub. Date: Jul. 29, 2010

(54) ALERT MESSAGING IN A TELEVISION SYSTEM

(75) Inventor: Lars Ake Wern, Stockholm (SE)

Correspondence Address: DENNISON, SCHULTZ & MACDONALD, 1727 KING STREET, SUITE 105, ALEXANDRIA, VA, 22314, US

(73) Assignee: INVIEW AB, Kista (SE)

(21) Appl. No.: 12/602,117

(22) PCT Filed: May 14, 2008
(86) PCT No.: PCT/SE2008/000332

§ 371 Date: Dec. 28, 2009

(30) Foreign Application Priority Data
May 29, 2007 (SE) 0701290-9

(51) Int. Cl. H04N 7/173

(52) U.S. Cl. 725/110

(57) ABSTRACT

A television system in which a telephone network is used for transmitting to a television receiver from a computer messages in the form of packets of information represented visually as pages. The television receiver is provided with control means for transmitting responses via the telephone network and for selecting a page, and the packets of information are stored by the computer in the form of information blocks each including a first information packet representing the message of a corresponding page and a second information packet representing data relating to the same page. The information blocks further include a third information packet to be received by the computer from a remote terminal via the telephone network and to instruct the computer to make such a transmittal that the data are represented visually at the television receiver as information added to the messages in a chosen subfield of the page. In a preferred embodiment, the computer is provided with a physical security monitoring system and arranged to make the transmittal dependent on local events detected by this system.

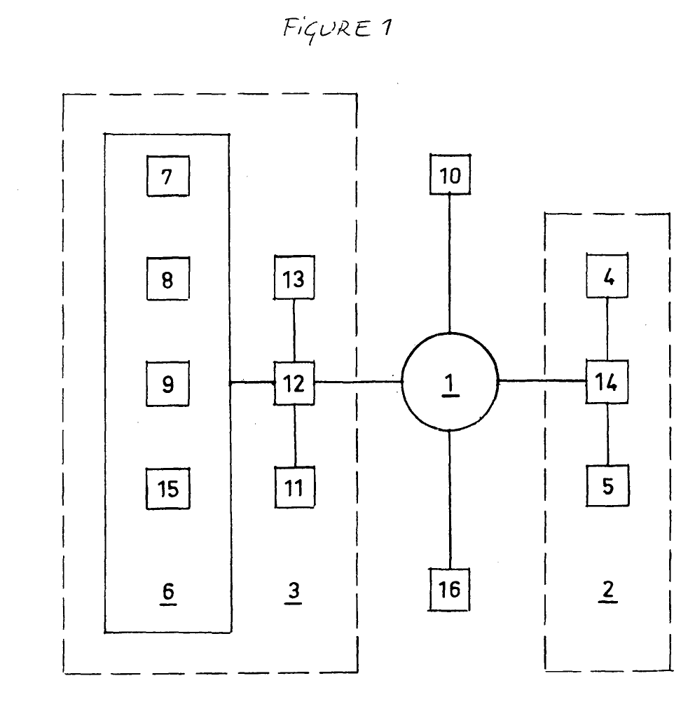

### FIELD OF INVENTION

The invention relates to a television system in which a telephone network is used for transmitting to a television receiver from a computer messages in the form of packets of information represented visually as pages, said television receiver being provided with control means for transmitting responses via the telephone network and for selecting a page, and said packets of information being stored by the computer in the form of information blocks each comprising a first information packet representing a message of a corresponding page and a second information packet representing data relating to the same page.

### BACKGROUND OF THE INVENTION

A system as defined above was more than 30 years ago pioneered by the UK Post Office and is described in U.S. Pat. No. 4,873,662. Domestic television receivers were proposed to present pages received via the public telephone network from a computer that stored hidden data relating to the presented pages. Home computers replaced quickly television receivers as terminals, and mobile phones are now becoming capable of replacing at least temporarily both the home computer and the domestic television receiver. The convenience of the latter device can, however, in a near future make it attractive as a terminal for Short Message Services (SMS) and Multimedia Message Services (MMS) provided via GSM telephone networks as well as for E-mail and other Internet services.

While added uses can reduce the convenience, the domestic television receiver has already become a center of many marketed multimedia system solutions. Since home security is of interest to everybody and is for the man skilled in the art an easy problem to solve at a low cost as a combined use of such common devices as a home computer and a mobile phone, it is presumably a recognized risk of user inconvenience that has been prohibitive for the potential market of such solutions as well as of television receivers adapted for the same purpose.

### SUMMARY OF THE INVENTION

A main object of the invention is to make domestic television receivers capable of providing home security at a low cost by means of such technical solutions that are described in SE527449 and PCT/SE2005/001683 and that are suitable to uphold the convenience of the television receiver at the same time as a physical security monitoring system can be provided for people as well as for pets and properties in general. Another object is to adapt television receivers to provide a plurality of conveniently administrated information services that are capable of catching the attention as breaking news.

The information blocks in the above defined television system comprise, according to the invention, a third information packet arranged to be received from a remote terminal via the telephone network and to instruct said computer to make such a transmittal that said data are represented visually at the television receiver as information added to said messages in a chosen subfield of said page. In a preferred embodiment of the invention, the computer is provided with a physical security monitoring system and arranged to make said transmittal dependent on local events detected by this system, such as fire, intrusion or the like. Other characteristics of the invention will appear from the description and the claims.

The television system of the invention will now be described more in detail with reference made to the accompanying drawing that shows a preferred embodiment.

### PREFERRED EMBODIMENT

In the drawing, a television system is shown in which a GSM telephone network 1 is used for transmitting to a television receiver 2 from a computer 3 messages in the form of packets of information represented visually as pages on a screen 4, the television receiver 2 being provided with control means 5 for transmitting responses via the telephone network 1 and for selecting a page, and said packets of information being stored by the computer 3 in a memory 6 and in the form of information blocks each comprising a first information packet 7 representing a message of a corresponding page and a second information packet 8 representing data relating to the same page.

According to the invention, the information blocks comprise a third information packet 9 arranged to be received by the computer 3 from a remote terminal 10 via the telephone network 1 and to instruct the computer 3 to make such a transmittal that said data are represented visually at the television receiver 2 as information added to said messages in a chosen subfield of said page, for example near the bottom. A common mobile phone is suitable to provide the function of the remote terminal 10.

The computer 3 is arranged to receive the third information packet 9 via SMS and is provided with a built-in physical security monitoring system 11 arranged to make said transmittal dependent on local events detected by means of technical solutions described in PCT/SE00/01183. In addition, the computer 3 is arranged to receive and store MMS images providing useful information in connection with detected local events as fire, intrusion or the like and to make said transmittal in the form of an alerting or alarming text string that is visually at the television receiver 2 added to a corresponding image.

Said information packet 8 presented visually at the television receiver 2 as a text string added to said messages in a chosen subfield of said page could as an option represent information of interest that is neither related to any local event nor necessarily to said message. According to the invention, a plurality of conveniently administrated information services can be provided that are capable of catching the attention as breaking news about a bargain sale or a traffic problem or a detected local event. In the preferred embodiment, the computer 3 comprises a multimedia terminal 12 connected to a screen 13 and capable of such services as provided by the television receiver 2, and the latter comprises a second multimedia terminal 14 capable of such services as provided by the computer 3. Adapting in this way two domestic television receivers to serve each one as either the terminal 2 or the computer 3, a low cost security system can be set up based upon an agreement between the users of the televisions receivers to act upon alerting or alarming text strings that are visually combined with image messages and are received from the other party by means of such technical solutions as described in SE527449 and PCT/SE2005/001683.

It is obvious for the man skilled in the art that there are many other possible embodiments of the invention, such as having the computer 3 arranged to receive text strings from the second multimedia terminal 14 without image messages and to present them on the screen 13 in the chosen subfield upon their reception and then added to previously received image messages retrieved locally for the purpose upon the reception of the text strings. This is advantageous since image messages received via MMS can be considerably delayed as compared to data received via SMS. For example, if the computer 3 has previously received and stored MMS images that show valuable properties, then it could be very useful to have these images automatically retrieved and presented on the screen 13 upon a reception of alerting or alarming SMS data.

In the preferred embodiment of the invention, the computer 3 is arranged to store a fourth information packet 15 arranged to be received from a second remote terminal 16 via the telephone network and to instruct the computer 3 to temporarily inhibit said transmittal. Representing one of a plurality of common mobile phones authorized by the remote terminal 10 and identified by their SIM card subscriber numbers when the information packet 15 is received by the computer 3, the second terminal 16 is a convenient remote control device for home security services that the computer 3 can provide by means of said transmittal.

In a multimedia phone embodiment, the television receiver 2 and the computer 3 can be as portable as the terminals 10 and 16 also in the preferred embodiment of the invention where a transmittal is made dependent on local events detected by the built-in physical security monitoring system 11 and where such sensor solutions as described in PCT/SE00/01183 are capable of providing instant security services anytime and anywhere, for example when the user goes to sleep in a hotel room.

1. Television system in which a telephone network (1) is used for transmitting to a television receiver (2) from a computer (3) messages in the form of packets of information represented visually as pages, said television receiver being provided with control means (5) for transmitting responses via the telephone network and for selecting a page, and said packets of information being stored by said computer in the form of information blocks each comprising a first information packet (7) representing the message of a corresponding page and a second information packet (8) representing data relating to the same page, characterized thereby that said information blocks comprise a third information packet (9) arranged to be received from a remote terminal (10) via said telephone network and to instruct said computer to make such a transmittal that said data are represented visually at the television receiver as information added to said messages in a chosen subfield of said page.

2. Television system according to claim 1, characterized thereby that said computer comprises a multimedia terminal (12) capable of such services as provided by said television receiver, and that the latter comprises a second multimedia terminal (14) capable of such services as provided by said computer so that either one can for said transmittal serve as said television receiver or as said computer.

3. Television system according to claim 1 characterized thereby that said television receiver is arranged for a reception of said data from said computer without said messages and for presenting them in said chosen subfield added to previously received messages retrieved locally for this purpose upon said reception of said data.

4. Television system according to claim 1, characterized thereby that said computer is provided with a physical security monitoring system (11) and arranged to make said transmittal dependent on local events detected by this system.

5. Television system according to claim 4, characterized thereby that said computer is arranged to receive and store a plurality of images providing useful information in connection with said detected local events and to make said transmittal with said data in the form of alerting or alarming text strings relating to said images.

6. Television system according to claim 1, characterized thereby that said computer is arranged to store a fourth information packet (15) received from a second remote terminal (16) via said telephone network and arranged to instruct said computer to temporarily inhibit said transmittal.
